(19) United States
(12) Patent Application Publication
(10) Pub. No.: US 2020/0391147 A1
(43) Pub. Date: Dec. 17, 2020

(54) FILTER MEDIUM

(71) Applicant: TWE GmbH & Co. KG, Emsdetten (DE)

(72) Inventor: Elke SCHMALZ, Chemnitz (DE)

(21) Appl. No.: 16/970,933

(22) PCT Filed: Feb. 19, 2019
(86) PCT No.: PCT/EP2019/054093

§ 371 Date: Aug. 18, 2020

(30) Foreign Application Priority Data
Feb. 19, 2018 (DE) 10 2018 103 682.5

(51) Int. Cl. B01D 39/16; B01D 46/52; B01D 46/02; B01D 46/00

(52) U.S. Cl. CPC B01D 39/1623; B01D 46/521; B01D 46/023; B01D 46/0032; B01D 2239/1291; B01D 2239/0627; B01D 2239/0663; B01D 2239/0618; B01D 2239/0622; B01D 2239/0435

(57) ABSTRACT

The invention relates to a filter medium for pleated filter elements or pocket filters, said filter medium comprising at least two nonwoven layers that are connected to each other by interlacing the fibers; a method for the production of said filter medium; a method for electrically charging said filter medium; an electrically charged filter medium; and the use of the filter medium.

### BACKGROUND

The invention relates to a filter medium for pleated filter elements or pocket filters, wherein at least two nonwoven layers are connected to each other by interlacing the fibers, a method for its production, a method for electrically charging said filter medium, an electrically charged filter medium (electret) and the use of the filter medium.

### SUMMARY

To date the layers of multilayer filter media have been usually adhesively bonded to each other. The adhesive may impede the permeability. Another disadvantage is the aspect that very small particles accumulate in the voids between the layers. As a result, the pressure differential in conventional filters is often unnecessarily high or, more specifically, rises sharply higher relatively quickly.

There are also processes, in which the fine fiber layers are laid directly on a carrier layer. Then the layers are usually connected only loosely to each other. The surfaces of the fine fiber layers are not resistant to mechanical influences. Just a low level of stress alone will result in uneven surfaces with protruding fibers. In the case of these layers there is no abrasion resistant surface and no positive connection with the fine fibers.

Other processes in turn use partial welding or lamination of the filter layers. This partial connection or connection over the entire surface impedes the air flow through the filter, at least at the surfaces that are connected, and, in so doing, increases the filter resistance.

The document WO 2004 069378 describes an air filter, in which the nonwoven layers are adhesively bonded with hot melt adhesive fibers.

The document DE 101 36 256 describes the production of staple fibers on a carrier material.

In the document DE 20 2005 019 004 the layers are welded or laminated to each other. Here, too, the pressure differential is unnecessarily high.

The document DE 697 32 032 describes a filter, in which the layers are connected by melting and spray coating. Here, too, the pressure differential is unnecessarily high.

The document DE 198 04 940 describes a filter medium, in which a nonwoven layer is laid on a voluminous carrier layer, and the layers are bonded with liquid or gaseous high pressure media jets. The composite can consist of a fiber nonwoven fabric and/or a filament spunbond nonwoven fabric. Needling is considered to be disadvantageous in this document. A fine separation layer is not integrated.

The document WO 2011/112309 A1 describes a highly elastic nonwoven material for diaper closures having a high restoring force after deformations.

The document DE 699 10 660 T2 describes dust filter bags with layers of paper, wherein individual layers can be electrically charged.

### DETAILED DESCRIPTION

Therefore, the object of the present invention is to provide a multilayer filter medium for pleated filter elements or pocket filters, wherein the individual layers are connected to each other in a form fitting manner and at least one fine fiber layer is integrated in this composite in an abrasion resistant manner.

The problem, on which the invention is based, is solved in a first embodiment by means of a filter medium for pleated filter elements (for example, mini pleat filters) or pocket filters, said filter medium comprising at least two nonwoven layers, characterized in that at least two nonwoven layers are connected to each other by interlacing the fibers, wherein at least one of these layers is a fine fiber layer.

This feature has the advantage that the layers are connected in a form fitting manner and that in the case of very small particles the increase in the pressure differential is more uniform and slower than in the case of filters of the prior art and that the medium is suitable for fine dust filtration.

The filter medium of the present invention comprises preferably at least one spunlace layer and at least one fine fiber layer. Optionally the filter medium can also comprise a retention layer. The retention layer consists preferably of 1 to 3 layers of a parallel nonwoven.

The filter medium of the present invention comprises preferably exactly two nonwoven layers, if it is a filter medium for pleated filter media. In this case it is preferably a spunlace layer and a fine fiber layer. As an alternative to the fine fiber layer, a retention layer can also be used. If the filter medium consists of a spunlace layer and a fine fiber layer, then the spunlace layer is located preferably on the upstream side of the filter medium. If the filter medium consists of a spunlace layer and a retention layer, then the retention layer is located preferably on the upstream side of the filter medium.

If the filter medium is to be suitable for pocket filters, then there are preferably at least 3 fiber layers. Said fiber layers are preferably a retention layer, a spunlace layer and a fine fiber layer, with the retention layer located preferably on the upstream side of the filter medium.

Optionally a transition layer can be provided that is, for example, a spunlace layer. The spunlace layer is arranged preferably on the upstream side or between the retention layer and the fine fiber layer or on the downstream side.

The filter medium of the present invention belongs preferably to one of the particle filter classes ePM10, ePM2.5, ePM1, M5, M6, F7, F8, F9, E10, E11, MERV 8 to MERV 16. The initial separation efficiency for DEHS [=diethylhexyl sebacate] droplets having a size of 0.3 to 2.5 μm is preferably in a range of from 15 to 95%.

The filter medium comprises preferably less than 0.5% by weight of adsorbents (such as, for example, activated carbon). The nonwovens and the fibers that are described in this patent application are by definition not adsorbents, according to this invention.

The initial pressure differential of the filter medium of the present invention in the new state is preferably in a range of from 5 to 250 Pa. The initial pressure differential of the filter medium in the new state is, in particular, preferably in a range of from 5 to 400 Pa at a flow rate of 16.7 cm/s. The flow rate can also be measured at other velocities, for example, in a range of from 5 to 500 cm/s. The initial pressure differential for these flow rates is also preferably in a range of from 5 to 250 Pa.

The fibers or the nonwoven layers, which are intended for the filter medium and which are interlaced, are preferably not hydrophobic and charged. As a result, the fibers can be easily interlaced by means of water jets.

The filter medium has preferably a flexural rigidity of at least 1 N for a sample size of 10×10 cm. The flexural rigidity can be up to 50 N. A higher flexural rigidity has the advantage that these layers are easier to fold and then do not return again to their original state, but rather the fold is retained. In addition, pockets of pocket filters do not bulge as much and, as a result, do not impede the outflow of air from neighboring pockets. The flexural strength can be measured, for example, with a tensile testing machine from the Zwick company.

The elongation of the filter medium at maximum tensile strength is preferably in a range of from 0 to 150%, in particular, preferably in a range of from 30 to 100%. The elongation at maximum tensile strength can be determined, for example, according to ISO 9073-15 “Simple Strip Tensile Test on Two Dimensional Textile Structures”, Part 2, Nonwovens and Composites. This particularly low elasticity makes it possible for this material to be easily folded and also to be much more dimensionally stable in pocket filters.

The total thickness of the filter medium is preferably in a range of from 0.5 to 10 mm. If the total thickness of the filter medium is less than 0.5 mm, then the stiffness may be too low for the fold stability.

The mass per unit area of the filter medium is preferably in a range of from 50 to 400 g/m². If the mass per unit area of the filter medium is below this range, then the result may be a reduction in the dust retention capacity. If the mass per unit area is above this range, then it may be that the filter is not economically viable.

### Retention Layer

The filter medium has also preferably a retention layer.

The retention layer has preferably a mass per unit area in a range of from 20 to 200 g/m², more preferably 30 to 120 g/m², most preferably 40 to 90 g/m². The thickness of the retention layer is preferably in a range of from 0.8 to 6 mm, in particular, preferably 1 to 5 mm. The material of the retention layer is preferably a parallel nonwoven (in this case the fibers are oriented in the machine direction). The nonwoven of the retention layer is formed preferably by polyolefin fibers. However, the nonwoven can also be made entirely or partially from polyester fibers (for example, polyethylene terephthalate). The polyethylene terephthalate can also be preferably at least partially a copolymer of polyethylene terephthalate. A polyolefin fiber nonwoven has the advantage that it is easier to charge electrically than nonwovens made from polyethylene terephthalate. The proportion of polyethylene terephthalate (PET) in the retention layer is preferably in a range of from 30 to 100% by weight.

Polyethylene and polypropylene fibers are particularly preferred as the polyolefin fibers.

The nonwoven of the retention layer is preferably thermally bonded. This feature has the advantage that said nonwoven has then a particularly high retention capacity in the composite, since it keeps its volume.

The retention layer can consist preferably of one to three layers that are produced, for example, in one working step. The material is preferably a parallel nonwoven. As an alternative, it can also be a laid nonwoven.

### Spunlace Layer

The spunlace layer is preferably a hydroentangled fiber nonwoven. The material of the spunlace layer is formed preferably by polyolefin fibers. However, the nonwoven can also be made entirely or partially from polyester fibers (for example, polyethylene terephthalate), or else copolymer fibers or bicomponent fibers. The mass per unit area of the spunlace layer is preferably in a range of from 30 to 200 g/m². The spunlace layer has preferably a thickness in a range of from 0.5 to 2 mm. The spunlace layer is entangled preferably in one work step and bonded to the fine fiber layer by means of high-energy water jets. In this case the pressure levels of the water jets are, for example, in a range of from 4 to 20 MPa. The entanglement and the layer bonding take place in the hydroentangling system. The holes in the nozzle strips of the entangling bar have, for example, diameters between 0.05 mm and 0.13 mm and are arranged in one, two or three rows. Preferably two or three entangling bars are used. However, the energy input can also be distributed over as many as up to five entangling bars.

For pleated filters, the spunlace layer can have preferably a content of more than 40% by weight of bicomponent fibers and/or hot melt adhesive fibers.

The spunlace layer can also be structured three dimensionally. The advantages of a 3D structure are the enlargement of the surface and, thus, a higher dust retention capacity. In filter media for pleated filter elements, the 3D structure acts at the same time as a spacer between the folds. In order to achieve the 3D structure, drums or interchangeable shells with a pattern or corresponding openings on the entangling drums, respectively, are used. The 3D structure is fixed, for example, by a subsequent thermal treatment.

The fibers of the spunlace layer have preferably a length in a range of from 38 to 60 mm.

### Fine Fiber Layer

The material of the fine fiber layer is preferably polypropylene, polyethylene, polycarbonate and/or polyester. The polyester can be preferably polybutylene terephthalate. Special preference is given to the material polypropylene.

The fine fiber layer can comprise ferroelectric material (such as, for example, perovskites, in particular, BaTiO₃ or AlTiO₃). These additives increase the charge stability. The ferroelectric material is comprised preferably in the fibers of the fine fiber layer and even more preferably dispersed in the polymer of the fibers (for example, as an additive). The content of ferroelectric material in the fine fiber layer is preferably in a range of from 0.01 to 50% by weight, based on the fiber mass.

The mass per unit area of the fine fiber layer is preferably in a range of from 5 to 50 g/m², even more preferably in a range of from 10 to 35 g/m². The preferred distribution of the fiber fineness in the fine fiber layer is in a range of from 0.1 μm to 4 μm with a maximum between 0.6 μm and 1.2 μm.

The fine fiber layer has preferably a thickness in a range of from 0.08 to 1 mm. For example, the pressure differential and the separation efficiency for small particles are set by means of the distribution of the fiber diameter in the fine fiber layer.

The fine fiber layer can consist preferably of one, two or three layers. It can also be applied to a nonwoven backing fabric (stiffness substrate or, more specifically, substrate layer), preferably a filament spunbond nonwoven fabric or a thermally bonded fiber nonwoven fabric having a mass per unit area in a range of from 10 g/m2 to 200 g/m². This nonwoven backing fabric can be arranged between the fine fiber layer and the retention layer or on the downstream side or upstream side.

The fibers of the fine fiber layer have preferably in the median an average diameter in a range of from 600 to 1200 nm. The fiber fineness of the fibers in the fine fiber layer is preferably in a range of from 0.3 to 3.3 dtex.

At least one of the layers is preferably a melt blown nonwoven (microfiber spunbond nonwoven). At least one of the layers can also be, for example, a nanofiber layer.

If at least one layer is made of a melt blown nonwoven, then preferably none of the other layers is a nanofiber layer.

The elongation of the fine fiber layer at maximum tensile strength is preferably in a range of from 0 to 150%, in particular, preferably in a range of from 30 to 100%. The elongation at maximum tensile strength can be determined, for example, according to ISO 9073-15 “Simple Strip Tensile Test on Two Dimensional Textile Structures”, Part 2, Nonwovens and Composites. This particularly low elasticity allows the material to be unrolled without warping and processed without delay.

### Arrangement of the Layers

At least one further layer of a nonwoven fabric, preferably filament spunbond nonwoven fabric or thermally bonded fiber nonwoven fabric (transition layer or protective layer) can be arranged between the retention layer and the spunlace layer and/or on the side of the fine fiber layer that faces away from the spunlace layer. This nonwoven fabric layer can have preferably a mass per unit area in a range of from 10 to 50 g/m². The material of this nonwoven fabric layer (transition layer or protective layer) is preferably polypropylene, polyethylene, or polyester.

This nonwoven fabric layer (transition layer or protective layer) is arranged, if necessary, preferably under the fine fiber layer and is connected to the spunlace layer in a form fitting manner by interlacing. At the same time this nonwoven fabric layer acts as a protective layer against abrasion from the outside.

The spunlace layer and the fine fiber layer are preferably connected to each other in a form fitting manner. Special preference is given to the spunlace layer and the fine fiber layer that are hydroentangled with one another. In this case the protective layer and/or the retention layer can also be entangled at the same time.

The retention layer can be connected to the spunlace layer in a form fitting manner. For example, hydroentanglement is used in conjunction with a thermal treatment. This process combination has the advantage that the required stiffness for folding is achieved, in addition to the bonding of the layers. However, as an alternative, it is also possible to simply place the retention layer on the composite of the other layers.

The retention layer can also be connected to the spunlace layer and also the fine fiber layer in a form fitting manner, even more preferably by means of hydroentanglement.

The spunlace layer and the fine fiber layer together have preferably a thickness in a range of from 0.7 to 1.5 mm.

The entire filter medium has preferably a thickness in a range of from 0.7 mm to 10 mm.

Preferably the filter medium does not comprise a layer that is not based on thermoplastic materials, and, in particular, does not comprise a layer made of metal, wood or paper. This aspect has the advantage that the filter medium can be easily thermoformed, melted, welded and glued.

Preferably the filter medium does not have a film, even more preferably does not have a polymer film. Similarly the filter medium does not have any paper or short cellulosic fibers. A film or paper, even if perforated, increases unnecessarily the pressure differential and impedes the flow.

Preferably the layers of the filter medium are not adhesively bonded to each other. Since no adhesive is used, the pressure differential can be reduced.

The filter medium of the present invention is preferably not impregnated with a resin or even provided with a hardened resin. As a result, it is possible to achieve a low pressure differential.

Adjacent layers are preferably bonded to each other with more than 90% of their respective areas; special preference is given to the entire surface of the adjacent layers being bonded to each other.

### Method for Producing the Filter Medium

In a further embodiment the problem, on which the invention is based, is solved by a method for producing the filter medium of the present invention, characterized in that at least two nonwoven layers are connected to each other in a form fitting manner by interlacing (for example, with high-energy water jets).

Preferably none of the nonwoven layers are formed in an organic solvent. This feature has the advantage that the production systems do not have to be protected against explosion.

High-energy water jets or steam jets are used preferably for the interlacing process. Water jets are particularly preferred.

A nonwoven fabric for the fine fiber layer is fed preferably to the hydroentangling system. This nonwoven fabric may have preferably the properties, described above, individually or in combination.

In addition to the nonwoven fabric for the fine fiber layer, fibers for the spunlace layer are also fed preferably to the hydroentangling system. These fibers can be carded preferably before being fed in and can be laid by means of lateral plaiting machines or crosslappers or can be fed in as a parallel nonwoven. These fibers may have preferably the properties of the spunlace layer, described above, individually or in combination. The nonwoven can be stretched preferably before it is fed to the interlacing apparatus.

For example, in addition to the nonwoven for the fine fiber layer and in addition to the fibers for the spunlace layer, a nonwoven/nonwoven fabric for the retention layer is fed to the interlacing apparatus. This nonwoven fabric may have preferably the properties, described above, individually or in combination.

After entanglement and production of the composite, the resulting filter medium can be calendered, in order to increase the rigidity, to reduce the thickness and to compress.

After entanglement and layer bonding and possibly before calendering, the resulting filter medium is dried and fixed preferably in an oven.

After drying and/or calendering, the filter medium is preferably electrically charged. Electrical charging takes place preferably inline.

Electrical charging should be regarded for purposes of the invention as a synonym for polarization. In the technical field of filters these two terms are often used as synonyms.

In an additional embodiment the problem, on which the invention is based, is solved by means of a method for electrically charging the filter medium of the present invention, characterized in that the filter medium is charged electrically (for example, positively and/or negatively).

The filter medium is electrically charged preferably with a charging apparatus. The charging apparatus has preferably one to five, even more preferably, two to four, pairs of electrodes and counterelectrodes. The electrodes are coupled preferably to a generator. The voltage for charging is set preferably in a range of from 15 to 60 kV, in particular, preferably 20 to 30 kV. For charging purposes, the current intensity is set preferably in a range of from 1 to 10 mA, even more preferably in a range of from 2 to 5 mA. The distance from the electrode to the counterelectrode is set preferably to a distance in a range of from 10 to 40 mm. The working speed is set preferably in a range of from 10 to 100 m/min.

Optionally the charging apparatus can also be combined with the oven.

In another embodiment the problem, on which the invention is based, is solved by means of an electrically charged filter medium, which can be obtained by means of the aforementioned method.

In a further embodiment the problem, on which the invention is based, is solved by using the filter medium as a liquid filter (such as, for example, an oil filter or a fuel filter), an air filter (for example, as an engine intake air filter), a filter for air handling systems (air conditioning systems, ventilation systems), a filter for gas turbines, an indoor filter, even for vehicles, for collecting fine dust from the outside air, or as a filter for vacuum cleaners in the form of pleated filter elements, filter pouches or filter bags.

### Exemplary Embodiment

A polypropylene (PP) melt blown nonwoven fabric having a thickness of 0.25 mm and a mass per unit area of 25 g/m² was fed to a water jet system as a fine fiber layer. A nonwoven, made of a blend of PP and PP/PE fibers having a fiber length of 38 mm and having a mass per unit area of 70 g/m², was placed on the fine fiber layer before entering the hydroentangling system. The spunlace layer was produced from this fiber nonwoven. Then the formation of the nonwoven from these fibers was carried out by carding and laying by means of lateral plaiting machines. Thereafter these two layers were hydroentangled in the water jet system with the usual parameters and then dried and calendered. Drying was carried out at 149 deg. C. Then the filter medium was electrically charged in a charging apparatus with 4 pairs of electrodes and counterelectrodes at a voltage of from 20 to 30 kV for charging and at a current intensity of from 3.7 to 4.4 mA. The distance between the electrodes was 15 mm. The working speed during the charging process was 25 m/min.

The filter medium, described in this first exemplary embodiment, is characterized by the following textile physical values: mass per unit area: 105 g/m², thickness: 0.9 mm, air permeability: 430 l/(m²s). The resulting filter medium allowed at least 70% by weight of DEHS droplets (DEHS=diethylhexyl sebacate) with a particle size of from 0.3 μm to 2.5 μm to be filtered out of an air stream at a flow rate of 16.7 cm/second (MFP 3000). The pressure differential at the start of the filtration was 90 Pa.

The following filter medium was produced for a second exemplary embodiment:

A polypropylene (PP) melt blown nonwoven fabric having a thickness of 0.25 mm and a mass per unit area of 15 g/m² was fed to a water jet system as a fine fiber layer. In addition, a polypropylene filament spunbond nonwoven fabric (as a transition layer) having a mass per unit area of 15 g/m² was fed to the water jet system under the melt blown nonwoven fabric. A nonwoven, made of a mixture of PP and PP/PE fibers having a fiber length of 38 mm and having a mass per unit area of 70 g/m², was placed on this fine fiber layer before entering the hydroentangling system. The spunlace layer was produced from this fiber nonwoven. Then the formation of the nonwoven from these fibers was carried out by carding and laying by means of lateral plaiting machines. Thereafter these layers were hydroentangled in the water jet system with the usual parameters; and at the same time a three dimensional structure was produced. This structuring was carried out by means of water jet entanglement on a cylinder that had holes with a diameter of 6 mm. The pressure of the water jets pushed the fibers of the layers into these holes, so that a three dimensional structuring was obtained. Drying and fixing took place at 149 deg. C.

Then a parallel nonwoven was additionally also placed on the filament spunbond nonwoven fabric layer as a retention layer. The parallel nonwoven consisted of polyester fibers with a mass per unit area of 60 g/m².

The filter medium, described in this second exemplary embodiment, is characterized by the following textile physical values: mass per unit area: 160 g/m², thickness: 3.9 mm, air permeability: 860 l/(m²s). The resulting filter medium allowed at least 35% by weight of DEHS droplets (DEHS=diethylhexyl sebacate) with a particle size of from 0.3 μm to 2.5 μm to be filtered out of an air stream at a flow rate of 16.7 cm/second (MFP 3000). The pressure differential at the start of the filtration was 90 Pa. In the finished filter medium the composite, composed of spunlace layer, fine fiber layer and filament spunbond nonwoven fabric layer, had a thickness of approximately 1.65 mm, while the retention layer had a thickness of 2.25 mm.

The features of the invention that are disclosed in the present specification, in the drawings and in the claims may be essential not only individually, but also in any combination for achieving the invention in its various embodiments. The invention is not restricted to the described embodiments. The invention can be varied within the scope of the claims and taking into account the knowledge of the competent person skilled in the art.

1. A filter medium for pleated filter elements or pocket filters, comprising at least two nonwoven layers connected to each other by interlacing the fibers, wherein at least one of the at least two nonwoven layers is a fine fiber layer.

2. The filter medium of claim 1, wherein an initial pressure differential of the filter medium in a new state is in a range of from 5 to 400 Pa at a flow rate of 16.7 cm/s.

3. The filter medium of claim 1, wherein the filter medium comprises at least one spunlace layer and at least one fine fiber layer.

4. The filter medium of claim 1, wherein the filter medium comprises at least one spunlace and at least one fine fiber layer, and additionally a retention layer, wherein the retention layer consists preferably of 1 to 3 layers of a parallel nonwoven.

5. The filter medium of claim 1, wherein the fine fiber layer consists of one, two or three layers, wherein, in particular, at least one layer is a melt blown nonwoven fabric.

6. The filter medium of claim 1, wherein the fine fiber layer has a thickness in a range of from 0.08 to 1 mm.

7. The Filter medium of claim 3, wherein the at least one spunlace layer and the at least one fine fiber layer are connected to each other in a form fitting manner, in particular, by hydroentanglement.

8. A method of producing the filter medium of claim 1, wherein the at least two nonwoven layers are connected to each other in a form fitting manner by interlacing.

9. A method of producing the filter medium of claim 8, wherein at least two nonwoven layers are calendered after drying.

10. A method of producing the filter medium of claim 1, wherein the at least two nonwoven layers are electrically charged.

11. An electrically-charged filter medium obtained by the method of claim 10.

12. (canceled)

13. A method of filtering air or liquid, comprising passing the air or the liquid through the filter medium according to claim 1.

14. The method of claim 13, wherein the filter medium is configured in a manner selected from the group consisting of a filter for air handling systems, a filter for gas turbines, an indoor filter, a filter for collecting fine dust from the outside air, and a filter for a vacuum cleaner.
